(19) United States
(12) Patent Application Publication
(10) Pub. No.: US 2026/0088980 A1
(43) Pub. Date: Mar. 26, 2026

(54) A QUANTUM PUBLIC KEY INFRASTRUCTURE (QPKI) SYSTEM

(71) Applicant: QuSecure, Inc, Petaluma, CA (US)

(72) Inventor: Mark C. Reynold, Concord, MA (US)

(21) Appl. No.: 19/109,428

(22) PCT Filed: Jan. 13, 2023
(86) PCT No.: PCT/US2023/060679

§ 371 Date: Mar. 6, 2025

(51) Int. Cl. H04L 9/08

(52) U.S. Cl. CPC H04L 9/0852

(57) ABSTRACT

A quantum public key infrastructure (QPKI) system allowing for secure communications between a plurality of users and/or systems, comprising a quantum public key infrastructure (QPKI) machine, the machine comprises a quantum resistant cryptography (QRC)-Enabled Certificate Authority, the machine implements QRC-Enabled IP and Web Protocols to provide a QRC-Enabled PKI Ecosystem.

### CROSS-REFERENCE TO RELATED APPLICATIONS

This application claims the benefit of priority of U.S. Provisional Application No. 63/404,894, titled “Method For a Quantum Public Key Infrastructure System” and filed on Sep. 8, 2023.

### BACKGROUND OF THE INVENTION

A Public Key Infrastructure (PKI) is a collection of digital objects used to manage resources. Despite the name a PKI can not only manage (public private) key pairs in asymmetric cryptography, but also any digital object with a valid encoding, including symmetric keys, IP address ranges, autonomous system numbers and many other objects. In order for an object to have a valid encoding it must satisfy the following constraints: 1. Can be represented in Abstract Syntax Notation v1 (ASN.1); 2. Have a unique serializable and invertible format using Distinguished Encoding Rules (DER); and be represented or representable in the ISO object identifier (OID) namespace. Note that a PKI object may have a more compact serialized representation using Basic Encoding Rules (BER). The BER format is optional, but the DER format is mandatory.

Almost all PKI systems currently deployed make use of classical cryptographic algorithms and are thus potentially vulnerable to quantum computers.

### SUMMARY OF THE INVENTION

In an aspect, the present disclosure provides a quantum public key infrastructure (QPKI) machine, comprising a quantum resistant cryptography (QRC)-Enabled Certificate Authority, the machine implements QRC-Enabled IP and Web Protocols to provide a QRC-Enabled PKI Ecosystem.

In another aspect, the present disclosure provides a quantum public key infrastructure (QPKI) system allowing for secure communications between a plurality of users and/or systems, comprising a quantum public key infrastructure (QPKI) machine, the machine comprises a quantum resistant cryptography (QRC)-Enabled Certificate Authority, the machine implements QRC-Enabled IP and Web Protocols to provide a QRC-Enabled PKI Ecosystem.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a block diagram of a quantum public key infrastructure (PKI) system, according to an embodiment of the present disclosure.

FIG. 2 is a flow diagram illustrating the making of a quantum public key infrastructure (PKI) system, according to an embodiment of the present disclosure.

FIG. 3 is a flow diagram illustrating the making of a quantum resistant cryptography (QRC)-Enabled Certificate Authority, according to an embodiment of the present disclosure.

FIG. 4 is a flow diagram illustrating the use of various protocols, according to an embodiment of the present disclosure.

FIG. 5 is a flow diagram illustrating the making of a QRC-Enabled PKI Ecosystem, according to an embodiment of the present disclosure.

FIG. 6 is a flow diagram illustrating the testing of the QRC-Enabled PKI Ecosystem, according to an embodiment of the present disclosure.

FIG. 7 is a flow diagram illustrating the use of a crypto discovery service, according to an embodiment of the present disclosure.

FIG. 8 is a flow diagram illustrating a quantum public key infrastructure (PKI) system that conducts user authentication, prepares digital signatures and works in hybrid operations, according to an embodiment of the present disclosure.

FIG. 9 is a block diagram of an example computer system, within the quantum public key infrastructure (PKI) system, which can perform any one or more of the functions described herein, in accordance with one or more aspects of the present disclosure.

### DETAILED DESCRIPTION OF THE INVENTION

The invention will now be described more fully hereinafter with reference to the accompanying drawings, in which illustrative embodiments of the invention are shown. While various embodiments of the invention are shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

The Quantum PKI (QPKI) architecture has two goals: to provide support for post-quantum algorithms, and to be backward compatible with existing PKI implementations. Deployments will thus be of three types: exclusively classical PKI; exclusively post-quantum PKI, and comprehensive PKI. In an exclusively classical PKI the objects in the QPKI will appear to be fully standards compliant PKI objects with optional (“non-critical”) post-quantum fields that will be ignored. In an exclusively post-quantum QPKI the standard PKI fields will be ignored and only the post-quantum fields will be used. A comprehensive or “dual-use” system will support both forms of resource management such that legacy components can be freely intermixed with post-quantum components. Processing using post-quantum fields, if present, will be tried first. If this fails, then a fallback to classical processing may be tried. It is a matter of system configuration whether or not this fallback is attempted.

In this disclosure we assume a QPKI configuration containing X509v3 certificates (“certs”). The QPKI may also contain Certificate Revocation Lists (“CRLs”), Manifests (“MANs”) and Trust Anchor Locators (“TALs”). Each of these digital objects are governed by one of more IETF standards. Note that certs and CRLs are DER encoded objects, so their fields are within known OID namespaces. MANs and TALs are currently text-encoded. These latter objects may be wrapped in Cryptographic Message Syntax (CMS). A QPKI should be prepared to support the text encoding and/or the CMS encoding. Note that CMS “envelop” fields are also in their own OID namespace. Finally, we assumed that the QPKI is organized into a set of repositories. A repository is typically presented as a web facing directory structure, although this presentation is not required; as long as path discovery and path validation (described below) are fully supported any type of network representation is permitted.

A subset of an OID namespace is referred to as an “arc”. Note that in a strict interpretation a leaf node of an OID namespace cannot be an arc, but many implementations permit a leaf node to be an arc containing only itself. Arcs are of three kinds: standard arcs, organization-specific arcs and non-standard arcs. Standard arcs must be represented by a published standards document, or it must be in a published document that is in a standards track. For example, the document that defines the arc for certs and CRLs is RFC5280 Appendix A. A PKIX specific arc is described as

```
  id-pkix OBJECT IDENTIFIER ::=
{ iso(1) identified-organization(3) dod(6) internet(1)
    security(5) mechanisms(5) pkix(7) }
```

in ASN.1 notation. Observe that each node has a (non-unique) name and a unique number. A subset of this arc for access descriptors is the arc defined by

id-ad OBJECT IDENTIFIER ::= { id-pkix 48 }
-- arc for access descriptors

Non-standard subsets of standard arcs are explicitly forbidden even if they do not have visibility outside the owning organization. Therefore, any strictly conforming implementation must reject

id-ad-bad OBJECT IDENTIFIER ::= { id-pkix 123456 }
-- invalid arc for any use

as an error, until and unless 123456 is published as a standard or draft standard.

An organization-specific arc is a subset of {joint-ise-ccitt (2) country (16) usa (840) org (1)}.

Once an organization has designated its own identifier A then the arc AORG::=2.16.840.1.A and all its subsets become valid as organization-specific arcs. (Note: there is another organization-specific arc within the iso (1) top level namespace; either may be used.)

Finally, any arc that is not a standard arc or an organization-specific arc is automatically a non-standard arc. Strictly conforming implementations should reject non-standard arcs as an error.

If S is a standard arc, then a classical PKI will only search for an exact match to S. In a QPKI with fallback the search order is as follows:

AORG.S
S
AORG.P.S

where P has at most five dotted components. In a QPKI without fallback only AORG.S is searched. The description that follows gives details for a QPKI discovery and validation sequence.

Standard verification consists of three steps: (1) checking specification compliance of the QPKI object(s) that reside in a (local) repository; (2) path discovery; and (3) path verification. All digital objects in the QPKI are governed by published specifications (such as the X509 certificate specification) that must be obeyed. The syntactic content of the specification is described using Abstract Syntax Notation v1 (ASN.1) and the Distinguished Encoding Rules (DER). Semantic rules narrow what is acceptable in practice. For example, an X509 certificate must have a “version” field encoded as binary 0, 1 or 2 corresponding to versions 1, 2 and 3. In order to be currently valid an X509 certificate must be version 3 (a semantic constraint). Mandatory fields must be present and must pass all syntactic and semantic checks. Digital objects may contain context-specific (optional) fields of two types: critical and non-critical. If a critical extension is present then it must be validated, but validation and interpretation of non-critical extensions is dependent on the context (classical PKI or QPKI). The presence of non-critical extensions means that a verification and validation sequence may use the same certificate in two different ways. Extensions are described by field names in the ASN.1 encoding, and also by Object Identifiers (OIDs). The OIDs form a hierarchical numerical namespace that forms an ontology managed by standards bodies (IANA, ETF, and ISE-CCITT in this case). The OID namespace contains reserved portions that may be used in a context-specific and/or organization-specific manner. The intent here is that a classical validation sequence will ignore the quantum specific non-critical extensions, while the quantum validation sequence can make use of them.

Path discovery is the process of discovering a chain of (child, parent) object relationships between an object (certificate) in a repository and an ultimate root of trust, also known as a trust anchor. A root of trust has at least one of the following three properties: (1) it is a member of a “Root” certificate store managed by the local cryptographic API (CAPI); (2) it is mentioned in a Trust Anchor Locator (TAL) record by unique URL, URI or URN (referred to subsequently as just a “URL”); or (3) is self-signed. Note that it is not part of the root of trust specification that a root be self-signed, but the majority of cryptographic libraries erroneously enforced this requirement.

A child object discovers its parent using a search algorithm. A search algorithm, in turn, is a pattern matching algorithm between one or more fields in the child object and one or more fields in the parent object. Two forms of search are typical: (1) the issuer field of the child matches all or part of the name of the parent; and (2) the authority key identifier (AKI) of the child exactly matches the subject key identifier (SKI) of the parent. Some organizations as part of their privacy policy may replace text strings with fixed but arbitrary random strings. In a perfect implementation this replacement would not break the pattern matching algorithm, but in practice this may not be the case. In the QPKI method (2) is preferred, but in a conforming implementation any pattern matching algorithm given in the specification must be supported.

Standard path discovery must meet the following conditions:
Every child has exactly one parent;
The path chain must contain at least two elements and at most six elements;
The path must be loop-free except that the root of trust may be its own parent;
No certificate in the path is expired;
No certificate in the path is revoked.

Expired certificates may be detected in two ways. The standard method is to compare the expiration date field in the certificate with the local time of machine hosting that certificate. If the expiration date is in the past, then the certificate is expired. A non-standard method is for the hosting organization to delete any expired certificates, causing path discovery to fail. While this approach is not fully standards compliant, it is not uncommon in practice.

Revoked certificates may be detected in three ways. Some implementations use Certificate Revocation Lists (CRLs). If a CRL exists that is a sibling of the certificate (they have the same issuer), and if the CRL data includes the unique serial number of the certificate, then that certificate is revoked. Some implementations use an Online Certificate Status Protocol (OCSP) server. This is a service in which a certificate is submitted to the OCSP server; the server then returns a status code indicating if the certificate is valid. Although OCSP is intended to detect revocation status it can also be used to detect expiration status. It is not an error for an implementation to use CRLs and OCSP in parallel. In the QPKI the use of CRLs is preferred as they are less subject to network attacks than OCSP. A conforming implementation must check both CRLs and OCSP and must make a pessimistic decision if the two methods produce different answers. Finally, an implementation may delete revoked certificates, which causes path discovery to fail.

The QPKI supports extended verification with the organization-specific namespace as described above. Extended verification includes the following extra steps:
A. Within the context-specific non-critical extensions in the organization-specific OID namespace a post-quantum encrypt/decrypt algorithm may be specified, using one of the NIST pq-candidate algorithms
B. Within the organization-specific OID namespace a pq sign/verify algorithm may be specified, using the NIST pq-candidate algorithms. Typically, this specifies a hash and/or HMAC algorithm, where the HMAC may be construed as a generalized form of signature
C. The root of trust must be specified in a Trust Anchor Locator record
D. Every certificate, CRL and TAL must be specified in at least one Manifest record
E. The hash of any item mentioned in “D” must match the item's hash recorded in all Manifests that list them
F. Every CRL must be “fresh”—the updateBy field in the CRL must be in the future
G. Every Manifest must be “fresh”—the updateBy field in the Manifest must be in the future

Note that an object that is not fresh is referred to as “stale.” Stale objects cannot be used in extended verification.

Just as path discovery proceeds upward starting with a PKI object in the repository, path validation proceeds downward from the trust anchor. Each parent object contains a key or key fragment that is used to verify the signature/HMAC of the child object. Failure to verify the signature/HMAC of the child is a fatal error. Note also that path validation is always an active computational process. Post-quantum algorithms may feature non-deterministic encryption and/or signing, so a simple binary comparison of the expected signature with the actual signature is insufficient. (Of course, decryption and signature verification must always be deterministic for all algorithms.)

Accordingly, an improved security system has been developed that is more resilient to non-classical computers attacks, such as quantum computers.

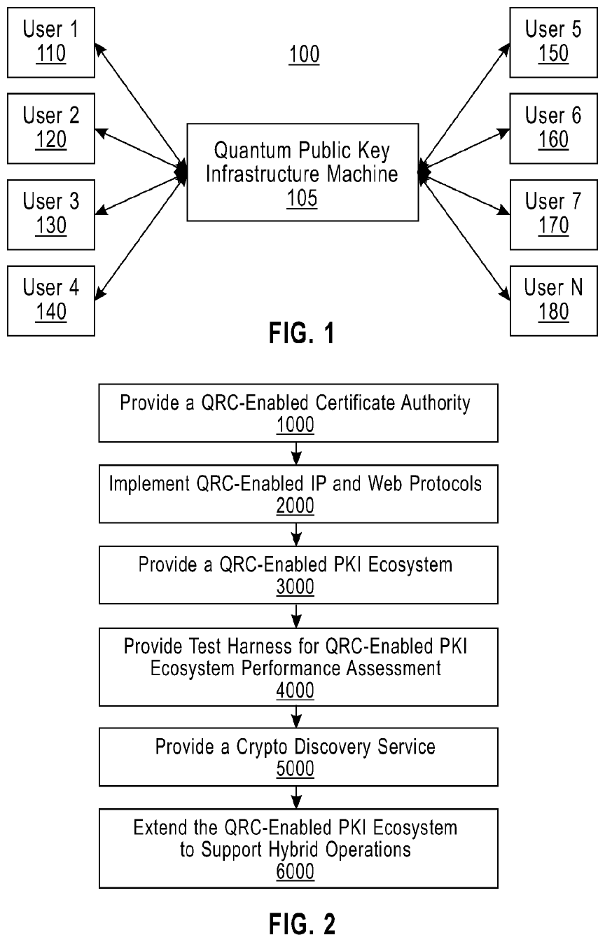

FIG. 1 is a block diagram of a quantum public key infrastructure (QPKI) system 100. The system 100 uses a quantum public key infrastructure (QPKI) machine 105 interacting with a plurality of users (110, 120, 130, 140, 150, 160, 170, 180). The quantum public key infrastructure (QPKI) machine 105 functions as described with reference to the above discussed figures and descriptions. Confidentiality and authentication are two aspects of data privacy protection. Confidentiality pertains to the treatment of information that an individual or entity has disclosed in a relationship of trust and with the expectation that it will not be divulged to others without permission in ways that are inconsistent with the understanding of the original disclosure. The quantum public key infrastructure (PKI) machine 105 allows the plurality of users (110, 120, 130, 140, 150, 160, 170, 180) to communicate with each other with the confidence that the exchanged information will be kept confidential.

FIG. 2 is a flow diagram illustrating the making of a quantum public key infrastructure (QPKI) system, according to an embodiment of the present disclosure. The making of the QPKI infrastructure system starts by providing a QRC-Enabled Certificate Authority 1000. Then QRC-Enabled IP and Web Protocols are implemented 2000. The making of the QPKI infrastructure system continues by providing a QRC-Enabled PKI Ecosystem 3000. It is essential in the making of the QPKI infrastructure system to include testing aspects. Provided is a Test Harness for QRC-Enabled PKI Ecosystem Performance Assessment 4000. The making of the QPKI infrastructure system continues by providing a Crypto Discovery Service 5000. The making of the QPKI infrastructure system is completed by extending the QRC-Enabled PKI Ecosystem to Support Hybrid Operations 6000. Details of each of the above components will be described hereafter.

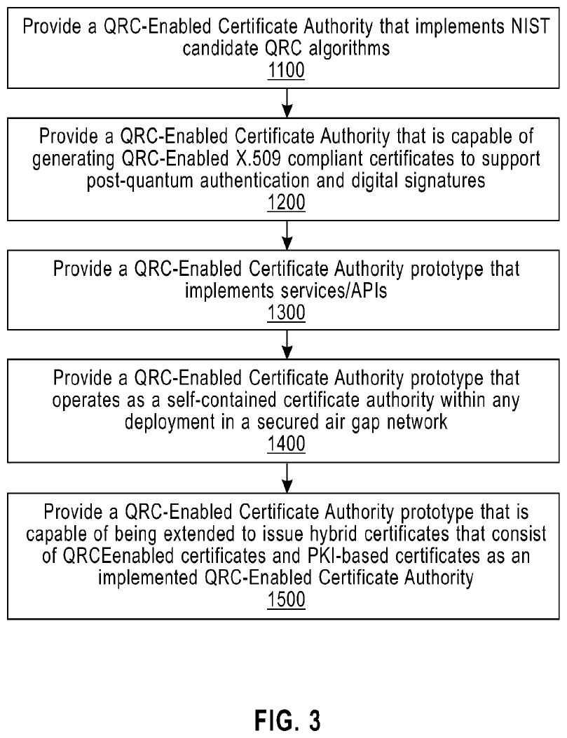

FIG. 3 is a flow diagram illustrating the making of a quantum resistant cryptography (QRC)-Enabled Certificate Authority, according to an embodiment of the present disclosure. The making of a quantum resistant cryptography (QRC)-Enabled Certificate Authority starts by providing a QRC-Enabled Certificate Authority that implements NIST candidate QRC algorithms 1100. Some of the NIST candidate QRC algorithms include:
a. CRYSTALS-Kyber (PKI)
b. SIKE (PKI)
c. CRYSTALS-Dilithium (SIGNATURE Algo.)
d. FALCONS (SIGNATURE, Co-dev Thales)
e. SHINCS+ (Signature)
f. BIKE (PKI)
g. Classic McEliece (PKI)
h. HQC Hamming Quasi-Cyclic (PKI).

The Quantum Resistant Cryptography listed is divided into two separate functional components. The first is a secure key encapsulation mechanism (KEM) such as CRYSTAL-KYBER. The second is digital signature schemes such as CRYSTAL-DILITHIUM.

The genesis of a QRC-Enabled Certificate Authority can be achieved and be enhanced to accommodate all NIST approved classical or quantum KEM algorithms, as well as approved classical or quantum NIST Signature algorithms. These algorithms will operate using an extensible plug-in architecture. Many libraries, including cryptographic libraries such as libcrypto, are already implemented using a function table. The name of an algorithm, such as “RSA” is used to select the appropriate row in the table, while the parameters, such as “512” control initialization and operation. Therefore, in the case of an RSA512 cryptosystem, the function pointer to encrypt( ) resolves to RSA_encrypt( ) with instance specific data pointing to 512-bit keys.

In such an architecture adding new algorithms involves updating the name-to-row function as well as adding all the implementations of the name-specific algorithms, such as KYBER_encrypt( ), KYBER_keygen( ) and so forth. Any algorithm of those listed above can be added once there are realizations of all the supported operations. Algorithm-specific auxiliary functions that are only implemented in some cryptosystems (but not all) can be accessed using a subtable. As an example of the latter consider a RLE system with a special operation “reset”. A call to lookup (“reset”) would resolve to a call to RLE_lookup(‘reset’) that would return a function pointer. For a cryptosystem that has no need for reset operation (ECDH being one of many examples), it would return NULL from the lookup operation.

Note that this approach allows polymorphism. A cryptosystem must support at least encrypt/decrypt but need not support sign/verify, while a signature system must support sign/verify. Uncommon operations such as reset would be accessed through the lookup mechanism, so that the number of columns of the function table could be kept small.

This design would allow for any of the Classical or Quantum based NIST KEM algorithms to be paired with any of the Classical or Quantum based NIST Signature Certificate algorithms increasing flexibility while securing data and communications with a variety of implementation choices.

The making of a quantum resistant cryptography (QRC)-Enabled Certificate Authority continues by providing a QRC-Enabled Certificate Authority that is capable of generating QRC-Enabled X.509 compliant certificates to support post-quantum authentication and digital signatures 1200.

Using a true NIST 800-90(A,B,C) certified photonics-based Quantum Random Number source of entropy increases the security guarantees that can be claimed for any cryptosystem operations that require (true) random numbers. Within x.509v3 certificates and other digital objects, the metadata can be extended to vendor-specific or implementation-specific fields that are tagged as “non-critical” (optional). Endpoints that do not understand these extensions can safely ignore them in a standards-compliant manner, while endpoints that do understand QRC can make use of these extensions and still be fully compliant as well. (See Task 6 for our proposed approach to hybrid processing.) These fields/metadata are encoded in the “organization specific” subset of the Object Identifier (OID) namespace. OIDs are a universal standard that must be supported by any organization that is compliant with any ISO standards.

The making of a quantum resistant cryptography (QRC)-Enabled Certificate Authority continues by providing a QRC-Enabled Certificate Authority prototype that implements services/APIs 1300. The services/API may include but not be limited to includes:
i. Viewing Certificates
j. Creating Certificates
k. Deleting Certificates
l. Requesting Certificates
m. Delivering Certificates.

The QRC-Enabled Certificate Authority will use a fully encrypted repository for the key lifecycle. This repository will employ an encrypted management console to the current keys with functionality including Viewing, Creating, Deleting, Revoking, Requesting, and Delivering Certificates. This functionality can also be accessed on the command line using a generalized version of the “openssl” tool or its equivalent.

Because this function is sensitive to attack it will include multi-layer encrypted authentication for any action dealing with a certificate and hardened Quantum TLS communications to each of the mutual authenticated endpoints. The management console and the command line tool can be set to localized to only execute locally to enhance security around the QRC-Enabled Certificate Authority, thus mitigating external threat. Enhanced communication between the management console display using post-quantum based communication techniques will ensure multiple levels of Identity for operations on each certificate and thus reduce the attack surface for intermediate actions within the repository or other functions within the QRC-Enabled Certificate Authority. As a final level of security path discovery (up from the EE certificate to the TA) and path validation (down from the TA to the EE) can always be re-executed in order to refresh any cached state.

The making of a quantum resistant cryptography (QRC)-Enabled Certificate Authority continues by providing a QRC-Enabled Certificate Authority prototype operates as a self-contained certificate authority within any deployment in a secured air gap network 1400.

The fully self-contained/self-reliant QRC-Enabled Certificate Authority will function within any isolated environment. Once the system is installed it is completely autonomous and will operate within an isolated environment without any requirement to contact other entities that may reside on a public network. Furthermore, inadvertent attempts to reach the public internet will be logged as errors. Log analysis can then be used to find and remediate the root cause of this error.

The making of a quantum resistant cryptography (QRC)-Enabled Certificate Authority continues by providing a QRC-Enabled Certificate Authority prototype that is capable of being extended to issue hybrid certificates that consist of QRC-enabled certificates and PKI-based certificates as an implemented QRC-Enabled Certificate Authority 1500.

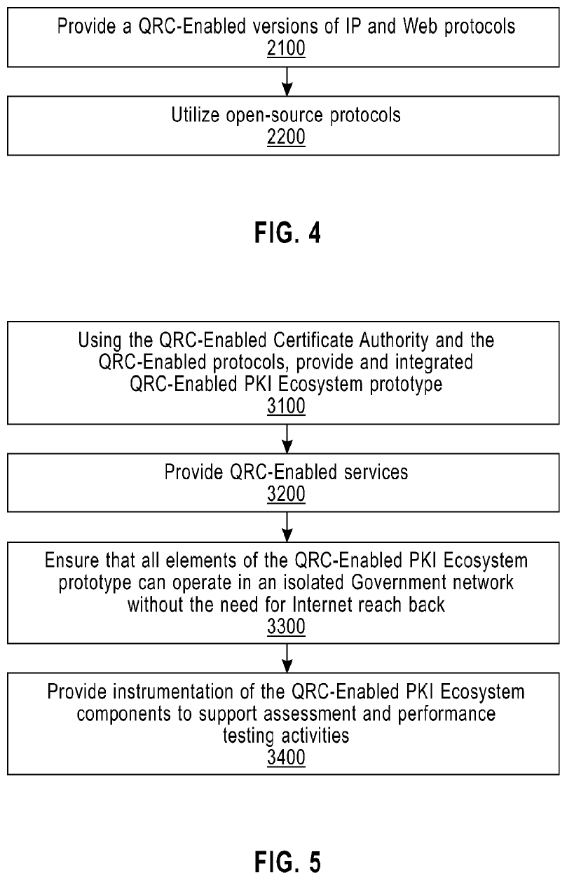

FIG. 4 is a flow diagram illustrating the use of various protocols as part of the quantum public key infrastructure (PKI) system. The system uses QRC-enabled versions of IP and Web protocols 2100 and open-source protocols 2200. Some of the QRC-enabled IP and Web protocols include:
a. Transport Layer Security (TLS) protocol (port=443)
b. Secure Shell (SSH) protocol (port=22)
c. Internet Protocol Security (IPSEC) protocol (ports=500 and 4500, 50-51)
d. Secure/Multipurpose Internet Mail Extensions (S/MIME) protocol (ports=995 pop3, 993 IMAP)

FIG. 5 is a flow diagram illustrating the making of a QRC-Enabled PKI Ecosystem. Using the QRC-Enabled Certificate Authority and the QRC-Enabled protocols, an integrated QRC-enabled PKI Ecosystem prototype can be made 3100. The ecosystem will include certificates and CRLs with optional support for Online Certificate Status Protocol (OCSP). The ecosystem will contain two other types of digital objects: the Trust Anchor Locator (TAL) and the Manifest. These objects increase the security of the PKI. PKIs often present themselves as a repository, a read-only network facing directory tree. The entire collection of repositories forms a linked ecosystem where path discovery proceeds upward until it reaches a top-level Trust Anchor (TA). This is a self-signed certificate that is used to validate its immediate children. Path validation proceeds downward from the TA to the ultimate end-entity (EE) certificates that form the leaf nodes within the organizational unit. The ecosystem will support CRLs, even if OCSP is enabled and running. Any CRLs that are created will be present in the filesystem view of the repository. Note that a CRL identifies the corresponding certificate by its serial number, so the ecosystem will ensure that all certificates ever created have a globally unique serial number. The Prototype ecosystem will be able to handle all aspects of certificate management lifecycle contained in an authenticated trust environment.

The QRC-Enabled PKI Ecosystem uses QRC-enabled services 3200 and ensures that all elements of the QRC-Enabled PKI Ecosystem prototype can operate in an isolated Government network without the need for Internet reach back 3200. The quantum public key infrastructure (PKI) system Provider will provide instrumentation of the QRC-Enabled PKI Ecosystem components to support assessment and performance testing activities 3400.

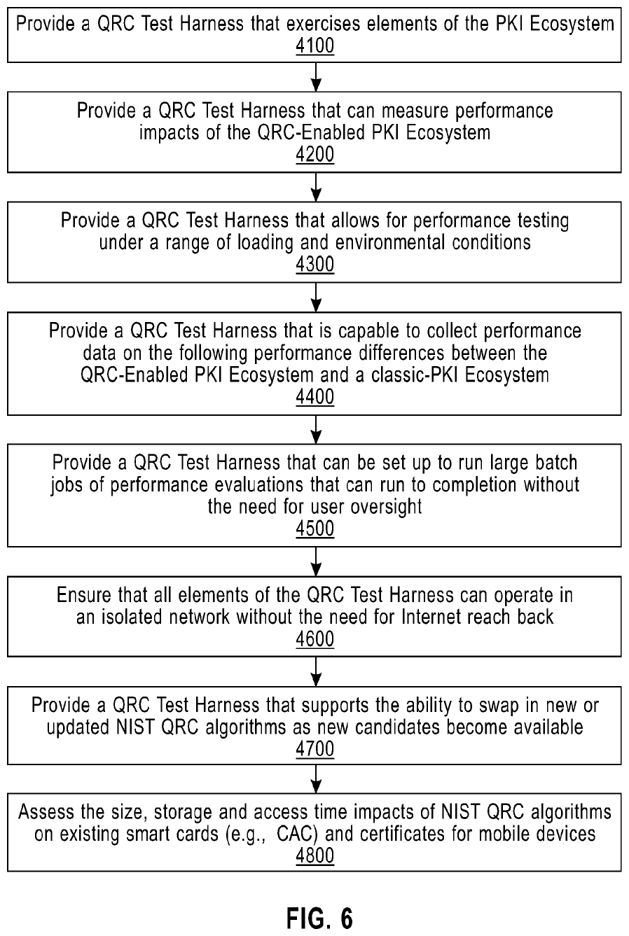

FIG. 6 is a flow diagram illustrating the testing of the QRC-Enabled PKI Ecosystem. The testing will include a QRC Test Harness that exercises elements of the PKI Ecosystem 4100, that can measure performance impacts of the QRC-Enabled PKI Ecosystem 4200 and allows for performance testing under a range of loading and environmental conditions 4300. The QRC Test Harness will collect performance data on the following performance differences between the QRC-Enabled PKI Ecosystem and a classic-PKI Ecosystem 4400, set up to run large set of batch jobs of performance evaluations that can run to completion without the need for user oversight 4500, can operate in an isolated network without the need for Internet reach back 4600, supports the ability to swap in new or updated NIST QRC algorithms as new candidates become available 4700 and assess the size, storage and access time impacts of NIST QRC algorithms on existing smart cards (e.g., CAC) and certificates for mobile devices 4800.

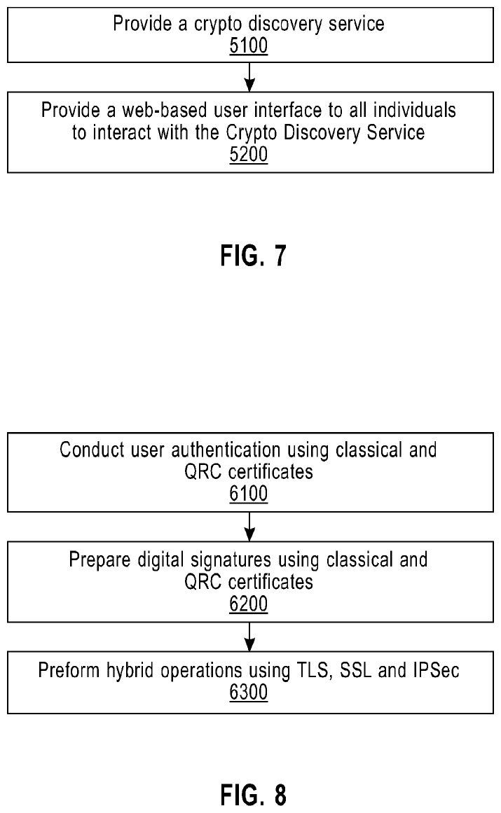

FIG. 7 is a flow diagram illustrating the use of a crypto discovery service as part of the quantum public key infrastructure (PKI) system. A crypto discovery service 5100 captures, categorizes, and presents the various versions of encryption configured and deployed on systems and networks. In detail crypto discovery service 5100 identifies and returns information to the requestor on what types and versions of encryption algorithms and protocols are configured and running on DoD networks, systems, endpoints (desktop, laptops and mobile devices) for both:
a. QRC enabled encryption algorithms and protocols
b. classical encryption algorithms and protocols

The general approach will be a combination of a publish/subscribe model with connectivity discovery implemented using programmatically callable nmap (network mapper) functionality. Each node will have a local whiteboard containing locally gleaned information, as well as links to the whiteboards of those nodes that are exactly one hop away. These links can only be written by the local information-gathering thread but can be read universally. No complex algorithms designed to prevent routing flaps or ensure that any kind of path is loop-free will be used. This is a trade-off between accuracy, useability and performance. The user must be aware that only a slice of the overall state of the system is available at any given time.

The quantum public key infrastructure (QPKI) system then provides a web-based user interface (webUI) to allow individuals to interact with the Crypto Discovery Service 5200. The webUI will implement filters that describe how a slice of the system is computed. Whiteboard-to-whiteboard links will be displayed as URL-style active hyperlinks that may be traversed. As with any active content a link may become unavailable if that connection is unavailable after the user selected it and the next update of the UI. This is the same issue that arises with the command line versions of nmap or similar tools

FIG. 8 is a flow diagram illustrating a quantum public key infrastructure (QPKI) system that conducts user authentication using classical and QRC certificates 6100. The system is built on “dual use” digital objects. These dual use objects (certificates, CRLs, Manifests and TAL) have elements described a hierarchical namespace of object identifiers (OIDs). Some of these OIDs can be described as well-known since they are specified as having fixed values in a published standard or draft standard. These well-known OIDs for all the digital objects of interest must be present in any valid classical object or QRC-enabled object. For classical objects all objects have a fixed root of [iso(1) identified-organization(3) dod(6) internet(1) security(5)]. Dual-use objects completely support the hybrid use.

The quantum public key infrastructure (QPKI) system then prepares digital signatures using classical and QRC certificates 6200.

The quantum public key infrastructure (PKI) system has the ability to conduct hybrid operations using TLS, SSL and IPSec 6300.

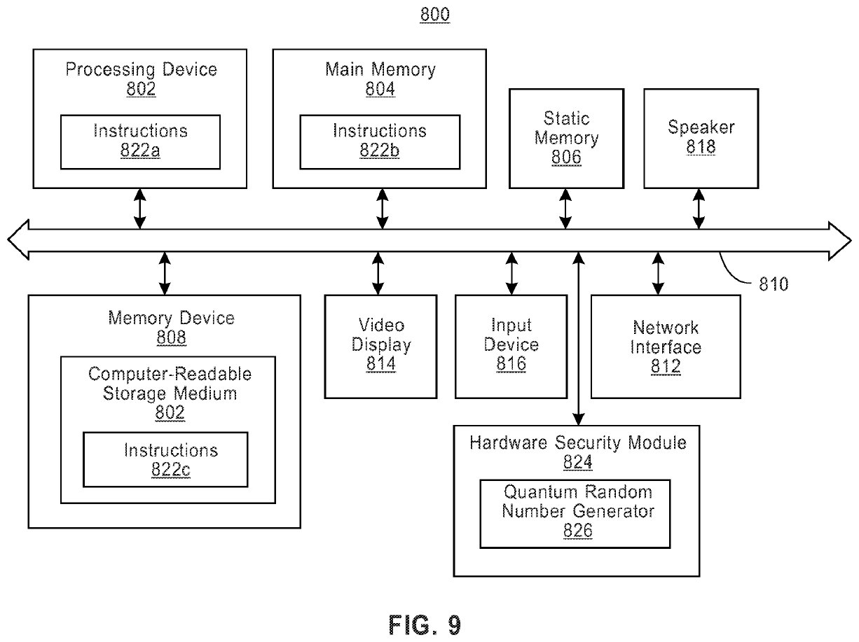

The computer system 800 (one example of a “computing device”) illustrated in FIG. 9 includes a processing device 802, a main memory 804 (e.g., read-only memory (ROM), flash memory, solid state drives (SSDs), dynamic random-access memory (DRAM) such as synchronous DRAM (SDRAM)), a static memory 806 (e.g., flash memory, solid state drives (SSDs), or static random-access memory (SRAM)), and a memory device 808, wherein any of the foregoing may communicate with each other via a bus 810. In some implementations, the computer system 800 may further include a hardware security module 824.

The processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a system on a chip (SoC), a field programmable gate array (FPGA), a digital signal processor (DSP), network processor, or the like. The processing device 802 may be configured to execute instructions for performing any of the operations and steps discussed herein.

The computer system 800 illustrated in FIG. 8 further includes a network interface device 812. The computer system 800 also may include a video display 814 (e.g., a liquid crystal display (LCD), a light-emitting diode (LED), an organic light-emitting diode (OLED), a quantum LED, a cathode ray tube (CRT), a shadow mask CRT, an aperture grille CRT, or a monochrome CRT), one or more input devices 816 (e.g., a keyboard and/or a mouse or a gaming-like control), and one or more speakers 818 (e.g., a speaker). In one illustrative example, the video display 814 and the one or more input devices 816 may be combined into a single component or device (e.g., an LCD touchscreen).

The memory device 808 may include a computer-readable storage medium 802 on which the instructions 822c embodying any one or more of the methods, operations, or functions described herein are stored. The instructions 822c may also reside, completely or at least partially, within the main memory 804 as instructions 822b and/or within the processing device 802 during execution thereof by the computer system 800. As such, the main memory 804 or as instruction 822a and the processing device 802 also constitute computer-readable media. The instructions 822 may further be transmitted or received over a network via the network interface device 812.

While the computer-readable storage medium 820 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium capable of storing, encoding, or carrying out a set of instructions for execution by the machine and that cause the machine to perform any one or more of the methods disclosed herein. The term “computer-readable storage medium” shall accordingly be taken to include, but not be limited to, solid-state memories, optical media, and magnetic media.

While the computer system environment of 800 shows the basic components the addition of a Hardware Security Module 824 associated with a Quantum Random Number Generator 826 are added to complete the entropy required for Post Quantum computations and interactions. The use of these components is critical as described previously in the overall methods used for this system.

No part of the description in this application should be read as implying that any particular element, step, or function is an essential element that must be included in the claim scope. The scope of patented subject matter is defined only by the claims. Moreover, none of the claims is intended to invoke 25 U.S.C. § 104 (f) unless the exact words “means for” are followed by a participle.

The foregoing description, for purposes of explanation, use specific nomenclature to provide a thorough understanding of the described embodiments. However, it should be apparent to one skilled in the art that the specific details are not required to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Once the above disclosure is fully appreciated, numerous variations and modifications will become apparent to those skilled in the art. It is intended that the following claims be interpreted to embrace all such variations and modifications.

1. A quantum public key infrastructure (QPKI) machine, comprising a quantum resistant cryptography (QRC)-Enabled Certificate Authority, the machine implements QRC-Enabled IP and Web Protocols to provide a QRC-Enabled PKI Ecosystem.

2. The machine of claim 1, wherein the QRC-Enabled Certificate Authority implements National Institute of Standards and Technology (NIST} candidate QRC algorithms.

3. The machine of claim 2, wherein the QRC-Enabled Certificate Authority generates QRC-Enabled X.509 compliant certificates to support post-quantum authentication and digital signatures.

4. The machine of claim 3, wherein the QRC-Enabled Certificate Authority provides a QRC-Enabled Certificate Authority prototype that implements services/APIs.

5. The machine of claim 4, wherein the QRC-Enabled Certificate Authority prototype operates as a self-contained certificate authority within any deployment in a secured air gap network.

6. The machine of claim 5, wherein the QRC-Enabled Certificate Authority prototype is capable of being extended to issue hybrid certificates that consist of QRC-enabled certificates and PKI-based certificates as an implemented QRC-Enabled Certificate Authority.

7. The machine of claim 1, further comprises a test harness for conducting a QRC-Enabled PKI Ecosystem Performance Assessment.

8. The machine of claim 7 further comprises a crypto discovery service.

9. The machine of claim 1, wherein the QRC-Enabled PKI Ecosystem supports hybrid operations.

10. A quantum public key infrastructure (QPKI) system allowing for secure communications between a plurality of users and/or systems, comprising a quantum public key infrastructure (QPKI) machine, the machine comprises a quantum resistant cryptography (QRC)-Enabled Certificate Authority, the machine implements QRC-Enabled IP and Web Protocols to provide a QRC-Enabled PKI Ecosystem.

11. The system of claim 10, wherein the QRC-Enabled Certificate Authority implements National Institute of Standards and Technology (NIST} candidate QRC algorithms.

12. The system of claim 11, wherein the QRC-Enabled Certificate Authority generates QRC-Enabled X.509 compliant certificates to support post-quantum authentication and digital signatures.

13. The system of claim 12, wherein the QRC-Enabled Certificate Authority provides a QRC-Enabled Certificate Authority prototype that implements services/APIs.

14. The system of claim 13, wherein the QRC-Enabled Certificate Authority prototype operates as a self-contained certificate authority within any deployment in a secured air gap network.

15. The system of claim 14, wherein the QRC-Enabled Certificate Authority prototype is capable of being extended to issue hybrid certificates that consist of QRC-enabled certificates and PKI-based certificates as an implemented QRC-Enabled Certificate Authority.

16. The system of claim 10, the machine further comprises a test harness for conducting a QRC-Enabled PKI Ecosystem Performance Assessment.

17. The system of claim 16, the machine further comprises a crypto discovery service.

18. The system of claim 10, wherein the QRC-Enabled PKI Ecosystem supports hybrid operations.
